(19) United States
(12) Patent Application Publication
(10) Pub. No.: US 2011/0177286 A1
(43) Pub. Date: Jul. 21, 2011

(54) COMPONENT COMPOSITE AND METHOD FOR MANUFACTURING A COMPONENT COMPOSITE

(76) Inventors: Martin Maier, Moeglingen (DE); Wilfried Aichele, Winnenden (DE); Nikolaus Hautmann, Ditzingen (DE); Michael Honer, Gerlingen (DE); Juergen Lander, Stuttgart (DE); Jens Koenig, Markgroeningen (DE)

(21) Appl. No.: 12/737,566

(22) PCT Filed: Jul. 28, 2009
(86) PCT No.: PCT/EP2009/059701

§ 371 Date: Apr. 7, 2011

(30) Foreign Application Priority Data
Jul. 28, 2008 (DE) 102008040782.8

(51) Int. Cl. B32B 3/00; B32B 38/10

(52) U.S. Cl. 428/141; 156/272.2

(57) ABSTRACT

A component composite, in particular for motor vehicle applications, include a first component having a first contact surface and at least one second component having a second contact surface, which presses against the first contact surface, the first contact surface having a surface structure, which is produced using electromagnetic radiation. The surface structure has a microstructure overlaid by a nanostructure.

### BACKGROUND OF THE INVENTION

1. Field of the Invention

The present invention relates to a component composite and a method for manufacturing a component composite.

2. Description of the Related Art

Extrusion-coating of metal parts using plastic is known, macroscopic structures having undercuts, such as ribs or a waffle structure, for example, being provided on the metal parts in order to allow a form fit with the plastic material. Although the thermoplastics which are used do not adhere to the metal, with skilled exploitation of shrinkage tensions, gas tightness of the component composite may initially be achieved. This gas tightness is temporary in particular in the event of temperature and/or load changes or in the event of media influence, however.

Furthermore, chemically structuring the surface of metal parts and, using the injection-molding method, subsequently extruding a plastic part onto the surface structured in this way is known from patent specifications of the TaiseiPlas Company.

A metallic flat seal having at least one metallic seal layer is known from published German patent document DE 10 2004 034 824 B4. The metallic seal layer is provided with a surface structure, which is produced using laser radiation, and on which elastomeric material is applied.

### BRIEF SUMMARY OF THE INVENTION

The present invention is based on the object of manufacturing an alternative component composite, which is distinguished by particular robustness. The component composite is preferably to be reliably and permanently gas tight. The component composite is very particularly preferably to be suitable for connecting a component made of a thermoplastic to a further component, in particular by extrusion-coating. Furthermore, the object is to propose a method for manufacturing a component composite so optimized.

The present invention is based on the idea of structuring the surface of the first component of the component composite, by employing electromagnetic radiation before joining the two components, in such a way that a surface structure results, which has a nanostructure in addition to a microstructure. The nanostructure is to be situated in such a way that it is located on the microstructure, i.e., in such a way that the microstructure is overlaid by the nanostructure. Such a surface-structured component ensures improved adhesion between the at least two adjoining components in a component composite, it being particularly preferable if the two adjoining components are connected to one another in a form-fitting manner, in particular in an area outside the surface structure of the first component, to obtain a particularly robust component composite. The form fit is very particularly preferably manufactured by at least partial extrusion-coating, in this case increased strength and tightness being achieved even after the temperature change and/or load change and/or media storage due to the adhesion based on the surface structure, which is implemented in addition to the form fit.

Situating a surface structure implemented as described in a component composite ensures, with appropriate component material, a gas tightness which has resistance even in the event of temperature and/or load change as well as media influence, in particular aggressive media influence. In contrast to the metal-elastomer composite known from published German patent document DE 10 2004 034 824 B4, the component composite implemented according to the concept of the present invention is also suitable in particular for a component combination in which at least one of the components is made from a thermoplastic. A specific embodiment using duroplastic may also be implemented.

In one refinement of the present invention, it is advantageously provided that microstructure elements of the microstructure have a diameter from a size range between approximately 1 μm and approximately 999 μm. The nanostructure elements of the nanostructure particularly preferably additionally or alternatively have a diameter from a size range between approximately 1 nm and approximately 999 nm.

Laser radiation is particularly preferably used as the electromagnetic radiation for producing the surface structure. An ultra-short pulsed laser is very particularly preferably used for this purpose, it further being preferable if the surface structure is produced under the influence of a processing medium for increasing the efficiency and/or for passivation. Process gas, in particular inert gas, is advantageously used. The process gas is very particularly preferably helium or argon, which prevents the formation of an oxide layer on the first component, which preferably is made of steel or aluminum.

In one refinement of the present invention, it is advantageously provided that the radiation wavelength of the employed electromagnetic radiation, in particular the laser radiation, is selected from a value range between approximately 10 nm and approximately 11 μm. The wavelength is very particularly preferably selected from a wavelength range between approximately 200 nm and approximately 1500 nm. It is additionally or alternatively preferable to select the radiation pulse duration, in particular the laser beam pulse duration, from a value range between approximately 10 fs and approximately 10 μs, particularly preferably between approximately 100 fs and approximately 100 ps. Through the selection of appropriate radiation parameters, the desired surface structure may be provided, having a microstructure overlaid by a nanostructure.

A material pairing of the component composite in which the first component is made from metal, in particular steel, and the second component is made from plastic, in particular thermoplastic or duroplastic, is particularly preferable, it further being preferable if at least some portions, but preferably all of the first component, is extrusion-coated by the second component, which is made from plastic to establish a form-fitting connection. However, the present invention is not restricted to such a component pairing. It is particularly preferable if at least some portions, but preferably all of the first component, is made from metal and/or ceramic and/or plastic and/or semiconductor material, and/or at least some portions, but preferably all of the second component, is made from plastic. The adhesion induced by the surface structure causes a particularly reliable, solid connection, which is particularly preferably supported by a form fit.

A specific embodiment is particularly preferred in which the first component and the second component have at least approximately equal coefficients of thermal expansion, to be able to still ensure tightness reliably in the event of temperature variations.

The component composite is particularly preferably part of a fuel-injection system. It is also possible to implement a lead frame, in particular in a control unit, in a sensor or in an electrical plug using an above-described component composite. It is particularly preferable if the component composite is implemented as a plastic-coated (metal) bush, which is preferably used for fastening a plastic housing. Furthermore, it is advantageous if the component composite is part of a flexible conductor (Flexleiter) or an extrusion-coated ceramic part, in particular for a lambda sensor of an internal combustion engine.

The present invention also relates to a method for manufacturing a component composite, in particular an above-described component composite. The method includes structuring a contact surface of a first component before joining the first component with a second component. The core of the method according to the present invention is that a surface structure is provided on the first component, which has a microstructure overlaid by a nanostructure, to thus improve the strength and/or the tightness of the resulting connection.

It is very particularly preferable if the surface structuring is performed with the aid of electromagnetic radiation, preferably under the influence of a process medium, in particular under process gas atmosphere, in order to chemically change the component surface, for example, passivate it, and increase the structuring efficiency.

In a refinement of the present invention, it is advantageously provided that an ultra-short pulsed laser is used to produce the surface structure.

It is particularly preferable if the second component is connected to the first component in a form-fitting manner, preferably by extrusion-coating of the first component, in order to ensure a stable form fit in addition to the adhesion originating from the surface structuring.

One specific embodiment is very particularly preferred in which the structured first component is stored under an inert gas atmosphere, in particular under nitrogen atmosphere, at least until joining the second component, in order to prevent oxidation of the surface structure. The second component is very particularly preferably joined, in particular by at least partial extrusion-coating of the first component, under an inert gas atmosphere or vacuum.

### BRIEF DESCRIPTION OF THE DRAWINGS

FIG. 1 shows a perspective view of a first component having a surface structure.

FIG. 2 shows an enlarged detail from FIG. 1, which schematically shows the surface structure.

FIG. 3 shows a component composite, in a sectional side view, including the first component shown in FIG. 1 and a second component.

### DETAILED DESCRIPTION OF THE INVENTION

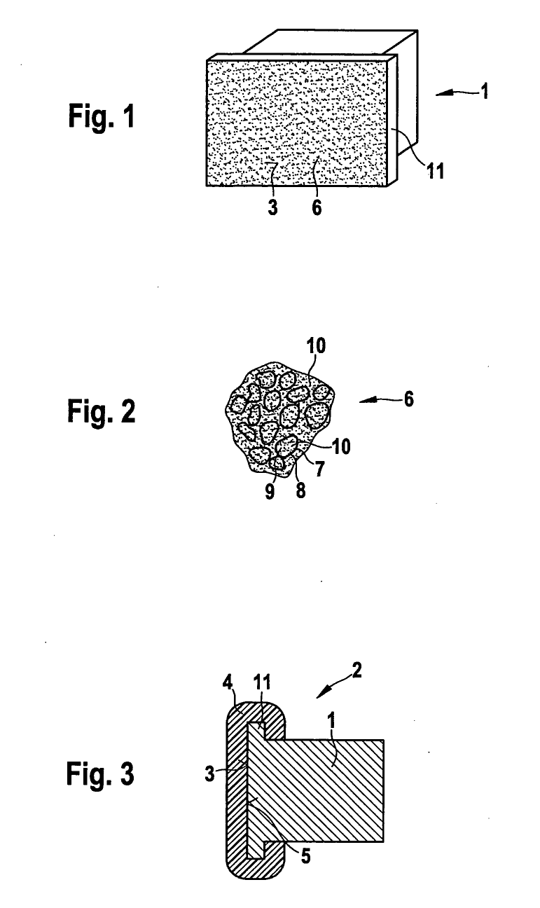

A first component 1 is shown in FIG. 1 as part of a component composite 2 shown in FIG. 3.

First component 1 is made from an aluminum alloy in the exemplary embodiment shown and includes a first contact surface 3, using which first component 1 presses against a second component 4, more precisely against a second contact surface 5 of second component 4, in component composite 2 shown in FIG. 3.

First component 1, more precisely first contact surface 3, is provided with a surface structure 6. This structure is schematically shown in FIG. 2 in an enlarged view. As shown in FIG. 1, first contact surface 3 is provided over its entire area with surface structure 6. Surface structure 6 shown in FIG. 2 includes a microstructure 7 having bulging and/or depressed microstructure elements 8. Microstructure elements 8 are provided with nanostructure elements 9 and a nanostructure 10, which is also located in the area outside microstructure elements 8. Adhesive forces act between first component 1 and second component 4 in component composite 2 shown in FIG. 3 due to the nanostructured/microstructured component surface (first contact surface 3).

Unstructured first contact surface 3 is first irradiated using a pulsed laser beam to manufacture surface structure 6. The laser beam is deflected using a scanner system in such a way that it scans the area of first component 1 to be structured.

To produce the desired surface structure, a femtosecond, picosecond, or nanosecond laser may be used, preferably having a pulse repetition frequency. The structuring process to manufacture surface structure 6 shown in FIG. 2 is preferably performed under process gas, to influence the formation of an oxide layer on first component 1 made from aluminum or steel. The advance with which the laser beam moves relative to first component 1 on first contact surface 3 is preferably between 100 mm/s and 10,000 mm/s.

To manufacture component composite 2 shown in FIG. 3, first component 1, more precisely first contact surface 3 having its surface structure 6, is extrusion-coated using second component 4, which is made of thermoplastic. The form fit between both components 1, 4 is ensured in that second component 4 encompasses a peripheral shoulder 11 of first component 1. Alternatively, for example, tabs, etc., which are extrusion-coated by second component 4, may be provided on first component 1. Second component 4 is particularly preferred. Second component 4 is particularly preferably made of fiberglass-reinforced and/or mineral-reinforced plastics, preferably thermoplastics or duroplastics, particularly preferably thermoplastic materials having a 30 to 60 weight-percent fiberglass and/or mineral portion. For example, molding compounds based on polyphenylene sulfide are suitable for component composites under media influence.

1-15. (canceled)

16. A component composite, comprising:
a first component having a first contact surface, the first contact surface having a surface structure produced using electromagnetic radiation, wherein the surface structure has a microstructure overlaid by a nanostructure; and
at least one second component having a second contact surface which presses against the first contact surface.

17. The component composite as recited in claim 16, wherein at least one of: (i) the microstructure has microstructure elements having a diameter in a range between approximately 1 μm and approximately 999 μm; and (ii) the nanostructure has nanostructure elements having a diameter in a range between approximately 1 nm and approximately 999 nm.

18. The component composite as recited in claim 17, wherein the surface structure is produced using a laser having a pulse duration between 100 fs and 100 ps, under a process gas atmosphere.

19. The component composite as recited in claim 17, wherein the surface structure is produced using at least one of: (i) a radiation wavelength in a range between approximately 10 nm and approximately 11 μm; and (ii) a radiation pulse duration in a range between approximately 100 fs and approximately 10 μs.

20. The component composite as recited in claim 17, wherein at least one of: (i) the first contact surface is made from at least one of metal, ceramic, thermoplastic, duroplastic and semiconductor material; and (ii) the second contact surface is made from one of thermoplastic or duroplastic.

21. The component composite as recited in claim 17, wherein the component composite is free of adhesion promoters, at least between the first and second contact surfaces.

22. The component composite as recited in claim 20, wherein the second contact surface is made from thermoplastic, and wherein at least portions of the first component are extrusion-coated by the second component.

23. The component composite as recited in claim 20, wherein the first and second components have at least approximately equal coefficients of thermal expansion.

24. The component composite as recited in claim 20, wherein the entire first contact surface is provided with the surface structure.

25. The component composite as recited in claim 20, wherein the component composite is part of one of: a fuel injector; a lead frame in one of a control unit, a sensor, or a plug; a flexible conductor; an extrusion-coated ceramic part for a lambda sensor; a bush which is extrusion-coated using plastic, for fastening a plastic housing of one of a control unit, a sensor, or a plug.

26. A method for manufacturing a component composite, comprising:
providing a first component having a first contact surface, the first contact surface being provided with a surface structure by using electromagnetic radiation, wherein the surface structure is produced in such a way that the surface structure has a microstructure overlaid by a nanostructure; and
providing at least one second component having a second contact surface which presses against the first contact surface.

27. The method as recited in claim 26, wherein the surface structure is produced under a process gas atmosphere.

28. The method as recited in claim 26, wherein the surface structure is produced using a laser having a pulse duration between 100 fs and 100 ps.

29. The method as recited in claim 26, wherein the first component is connected in a form-fitting manner to the second component after the surface structuring, the connection being provided by at least sectionally extrusion-coating the first component using the second component made from plastic material.

30. The method as recited in claim 29, wherein the first component having the surface structure is stored under an inert gas atmosphere until being connected with the second component.
